(19) United States
(12) Patent Application Publication
(10) Pub. No.: US 2024/0372142 A1
(43) Pub. Date: Nov. 7, 2024

(54) RECHARGEABLE LITHIUM BATTERY

(71) Applicant: SAMSUNG SDI CO., LTD., Yongin-si (KR)

(72) Inventors: Tae Hyon BAE, Yongin-si (KR); Harim LEE, Yongin-si (KR); Sanghyung KIM, Yongin-si (KR); Seunghyeon SON, Yongin-si (KR); Arum YU, Yongin-si (KR); Yunhee KIM, Yongin-si (KR)

(21) Appl. No.: 18/497,350

(22) Filed: Oct. 30, 2023

(30) Foreign Application Priority Data
May 3, 2023 (KR) 10-2023-0057930

(51) Int. Cl. H01M 10/0567; C07F 5/02; H01M 4/525; H01M 4/583; H01M 10/052; H01M 10/0568; H01M 10/0569; H01M 10/44

(52) U.S. Cl. CPC H01M 10/0567; C07F 5/025; H01M 4/525; H01M 4/583; H01M 10/052; H01M 10/0568; H01M 10/0569; H01M 10/44; H01M 2004/027; H01M 2004/028

(57) ABSTRACT

Disclosed is a rechargeable lithium battery including a positive electrode including a positive electrode active material, a negative electrode including a negative electrode active material, a separator between the positive electrode and the negative electrode, and an electrolyte, wherein a density of the negative electrode is greater than or equal to about 1.6 g/cc, the electrolyte includes a non-aqueous organic solvent, a lithium salt, and an additive, the non-aqueous organic solvent includes ethyl butyrate, and the additive includes a borate compound represented by Chemical Formula 1 and an Ag salt.

### CROSS-REFERENCE TO RELATED APPLICATION

The present application claims priority to and the benefit of Korean Patent Application No. 10-2023-0057930, filed on May 3, 2023, in the Korean Intellectual Property Office, the entire disclosure of which is incorporated herein by reference.

### BACKGROUND

### 1. Field

A rechargeable lithium battery is disclosed.

### 2. Description of the Related Art

Rechargeable lithium batteries are widely used as a driving power source for mobile information terminals such as smart phones and laptops because they are easy to carry while implementing high energy density. Recently, rechargeable lithium batteries having high capacity, high energy density, and high safety have been actively researched for use as a power source for driving a hybrid vehicle and/or an electric vehicle, and/or a power source for power storage.

In rechargeable lithium batteries, electrolytes play an important role of transporting lithium ions, wherein an electrolyte containing an organic solvent and a lithium salt may exhibit superbly high ion conductivity and thus is generally used. This electrolyte plays an important role in determining safety and performance of rechargeable lithium batteries.

Recently, as high-capacity and high-energy density batteries have been utilized, electrodes have been designed to have high energy density and operate batteries at a high density of 4.5 V or more. However, a positive electrode is deteriorated under harsh conditions such as a high voltage, while lithium dendrites grow on the surface of a negative electrode, accelerating a side reaction between electrodes and electrolyte and thereby reducing cycle-life of batteries and gas generation, etc. and resultantly, causing a battery safety problem.

In order to solve this problem, a method of suppressing or reducing the side reaction with the electrolyte by protecting the electrodes through a surface treatment has been proposed. However, the problems have been reported that the surface treatment of the positive electrode lacks the protection effect under high-voltage driving conditions, while the surface treatment of the negative electrode deteriorates capacity. Accordingly, development of an electrolyte capable of improving battery safety and performance in the design of high-capacity electrodes driven at a high voltage is desired.

### SUMMARY

Provided is a rechargeable lithium battery that secures battery safety under high-voltage driving conditions and has improved capacity characteristics and lifespan characteristics by suppressing or reducing discoloration of an electrolyte and suppressing or reducing generation of lithium dendrites in a negative electrode.

Some embodiments provide a rechargeable lithium battery including a positive electrode including a positive electrode active material, a negative electrode including a negative electrode active material, a separator between the positive electrode and the negative electrode, and an electrolyte,
wherein a density of the negative electrode is greater than or equal to about 1.6 g/cc, the electrolyte includes a non-aqueous organic solvent, a lithium salt, and an additive, the non-aqueous organic solvent includes ethyl butyrate, and the additive includes a borate compound represented by Chemical Formula 1 and an Ag salt.

LiBF₂[O₂C(CFX)ₙCO₂] Chemical Formula 1

In Chemical Formula 1, X is hydrogen, a halogen, a substituted or unsubstituted C1 to C4 alkyl group, or a C1 to C4 fluoroalkyl group substituted with at least one fluoro group, and n is an integer of 1 to 4.

A rechargeable lithium battery according to some embodiments suppresses or reduces discoloration of an electrolyte and suppresses or reduces generation of lithium dendrites in a negative electrode, thereby securing battery safety under high-voltage driving conditions and improving capacity characteristics and cycle-life characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic view of a rechargeable lithium battery according to some embodiments.

FIG. 2 is a series of photographs for observing discoloration of the electrolyte after leaving the electrolyte for a rechargeable lithium battery cell according to some embodiments at 45° C. for 5 days.

FIG. 3 is a graph showing capacity retention rates of the rechargeable lithium battery cells according to Examples and Comparative Examples 1 to 7 at 45° C. and 150 cycles.

FIG. 4 is a series of photographs showing whether or not lithium dendrites are generated in the rechargeable lithium battery cells according to Comparative Examples 5 to 7 and Examples.

### DETAILED DESCRIPTION

Hereinafter, example embodiments will be described in more detail so that those of ordinary skill in the art can easily implement them. However, the subject matter of this disclosure may be embodied in many different forms and is not construed as limited to the example embodiments set forth herein.

The terminology used herein is used to describe embodiments only, and is not intended to limit the present disclosure. As used herein, the singular expression includes the plural expression unless the context clearly dictates otherwise.

As used herein, “combination thereof” means a mixture, laminate, composite, copolymer, alloy, blend, reaction product, and/or the like of the constituents.

Herein, it should be understood that terms such as “comprises,” “includes,” or “have” are intended to designate the presence of an embodied feature, number, step, element, or a combination thereof, but do not preclude the possibility of the presence or addition of one or more other features, numbers, steps, elements, or a combination thereof.

In the drawings, the thickness of layers, films, panels, regions, etc., may be exaggerated for clarity and like reference numerals designate like elements throughout the specification. It will be understood that if an element such as a layer, film, region, or substrate is referred to as being “on” another element, it can be directly on the other element or intervening elements may also be present. In contrast, if an element is referred to as being “directly on” another element, there are no intervening elements present.

As used herein, the term “layer” includes not only a shape formed on the whole surface if viewed from a plan view, but also a shape formed on a partial surface.

According to embodiments of the present disclosure, the average particle diameter may be measured by any suitable method generally used in the art, for example, may be measured by a particle size analyzer, or may be measured by a transmission electron microscopic photograph or a scanning electron microscopic photograph. In some embodiments, it is possible to obtain an average particle diameter value by measuring using a dynamic light scattering method, performing data analysis, counting the number of particles for each particle size range, and calculating from the results. As used herein, if a definition is not otherwise provided, the average particle diameter may mean a diameter (D50) of particles having a cumulative volume of 50 vol % in a particle size distribution.

Herein, “or” is not to be construed as an exclusive meaning, for example, “A or B” is construed to include A, B, A+B, and/or the like.

As used herein, if a definition is not otherwise provided, “substituted” refers to replacement of hydrogen of a substituent or a compound by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. For example, “substituted” refers to replacement of at least one hydrogen of a substituent or a compound by deuterium, a halogen, a C1 to C5 alkyl group, a C6 to C18 aryl group, a C1 to C5 fluoroalkyl group. Or a cyano group. For example, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

### Rechargeable Lithium Battery

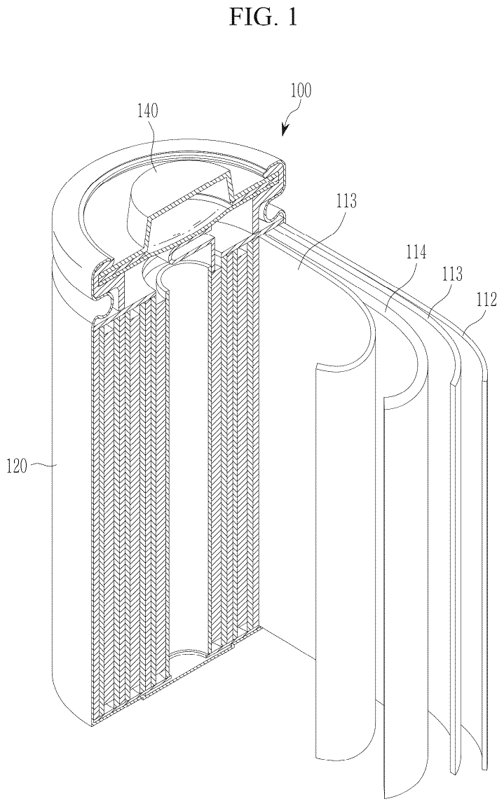

FIG. 1 is a schematic view of a rechargeable lithium battery according to some embodiments. Referring to FIG. 1, a rechargeable lithium battery 100 includes a battery cell including a positive electrode 114, a negative electrode 112 facing the positive electrode 114, a separator 113 between the positive electrode 114 and the negative electrode 112, and an electrolyte impregnating the positive electrode 114, the negative electrode 112, and the separator 113, a battery case 120 housing the battery cell, and a sealing member 140 sealing the battery case 120.

Some embodiments provide a rechargeable lithium battery including a positive electrode including a positive electrode active material, a negative electrode including a negative electrode active material, a separator between the positive electrode and the negative electrode, and an electrolyte, wherein a density of the negative electrode is greater than or equal to about 1.6 g/cc, the electrolyte includes a non-aqueous organic solvent, a lithium salt, and an additive, the non-aqueous organic solvent includes ethyl butyrate, and the additive includes a borate compound represented by Chemical Formula 1 and an Ag salt.

LiBF₂[O₂C(CFX)ₙCO₂] Chemical Formula 1

In Chemical Formula 1, X is hydrogen, a halogen, a substituted or unsubstituted C1 to C4 alkyl group, or a C1 to C4 fluoroalkyl group substituted with at least one fluoro group, and n is an integer of 1 to 4.

The rechargeable lithium battery 100 suppresses or reduces discoloration of the electrolyte and suppresses or reduces the generation of lithium dendrites in the negative electrode, thereby securing battery safety under high-voltage driving conditions and improving capacity characteristics and cycle-life characteristics.

For example, if a rechargeable lithium battery using a high-density negative electrode of greater than or equal to about 1.6 g/cc is driven at a high voltage, in embodiments that a non-aqueous organic solvent having excellent high-voltage characteristics is used, a borate compound and an Ag salt are concurrently (e.g., simultaneously) included as electrolyte additives, thereby suppressing or reducing discoloration of the electrolyte and suppressing or reducing generation of lithium dendrites in the negative electrode.

### Borate Compound

Non-aqueous organic solvents such as ethyl butyrate (EB) used in a high-voltage rechargeable lithium battery of 4.5 V or higher have excellent high-voltage characteristics, but there is a problem of discoloration by reacting with by-products such as HF generated by decomposition of lithium salt. Because the borate compound according to some embodiments has a function of trapping by-products such as HF, if used in combination with a non-aqueous organic solvent, discoloration of the electrolyte can be effectively inhibited or reduced.

The borate compound is represented by Chemical Formula 1.

LiBF₂[O₂C(CFX)ₙCO₂] Chemical Formula 1

In Chemical Formula 1, X is hydrogen, a halogen, a substituted or unsubstituted C1 to C4 alkyl group, or a C1 to C4 fluoroalkyl group substituted with at least one fluoro group, and n is an integer of 1 to 4.

For example, the borate compound may be represented by any one selected from Chemical Formula 1-1 to Chemical Formula 1-6.

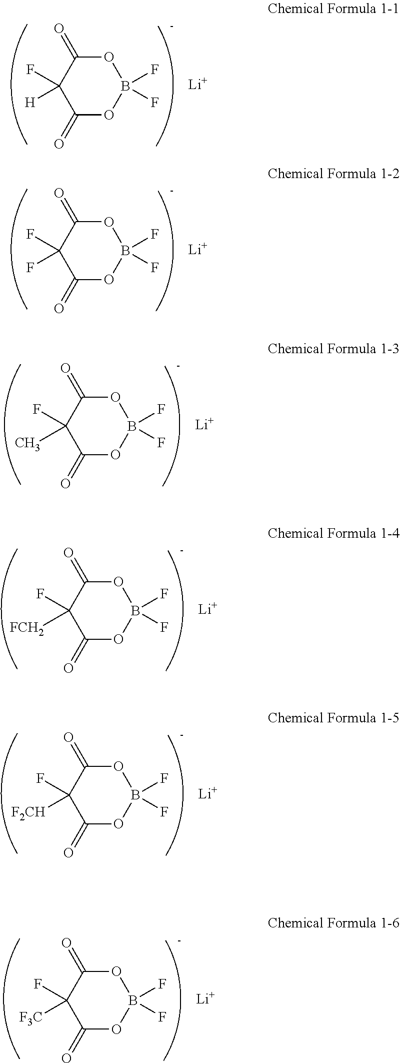

The borate compound may be included in an amount of about 1 wt % to about 10 wt % based on a total weight of the electrolyte. For example, the borate compound may be included in an amount of about 1 wt % to about 5 wt %, about 1 wt % to about 2.5 wt %, for example, about 1 wt % to about 2 wt %, based on 100 wt % of the electrolyte.

If the borate compound is included in the above ranges, it is possible to effectively improve (e.g., reduce, avoid, or inhibit) the discoloration of the electrolyte in the high-voltage rechargeable lithium battery.

### Ag Salt

The Ag salt can improve the conductivity of lithium ions in the negative electrode of the rechargeable lithium battery, thereby suppressing or reducing the growth of lithium dendrites generated on the surface of the negative electrode. Accordingly, the Ag salt may play a role of improving battery safety (e.g., increased battery cycle-life and suppression or reduction of gas generation) by reducing side reactions between the electrode and the electrolyte.

The Ag salt may include, for example, at least one selected from AgNO₃, AgNO₂, AgN₃, AgCN, AgPF₆, AgFSI, AgTFSI, AgF, AgSO₃CF₃, and AgBF₄.

For example, the Ag salt may include AgNO₃, AgNO₂, AgN₃, or AgCN. In some embodiments, the Ag salt may include AgNO₃.

The Ag salt may be included in an amount of about 0.1 wt % to about 10 wt % based on a total weight of the electrolyte for a rechargeable lithium battery. For example, the Ag salt may be included in an amount of about 0.1 wt % to about 5 wt %, about 0.1 wt % to about 2.5 wt %, for example, about 0.1 wt % to about 1.0 wt %, based on 100 wt % of the electrolyte.

If the Ag salt is included in the above ranges, the growth of lithium dendrites is effectively inhibited or reduced, so that a rechargeable lithium battery having improved battery safety can be realized.

The borate compound and the Ag salt may be included in a weight ratio of about 1:0.1 to about 1:1. In an example, the borate compound and the Ag salt may be included in a weight ratio of about 1:0.1 to about 1:0.5.

If the borate compound and the Ag salt are included in the above weight ratios, discoloration of the electrolyte is suppressed or reduced and generation of lithium dendrites in the negative electrode is suppressed or reduced, thereby effectively implementing a rechargeable lithium battery that secures battery safety under high-voltage driving conditions and improves capacity characteristics and cycle-life characteristics.

### OTHER ADDITIVES

The electrolyte for a rechargeable lithium battery may further include other additives other than those described above. If the other additives are further included, capacity characteristics and cycle-life characteristics of the battery may be further improved under high-voltage driving conditions.

The other additives may include at least one selected from vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), or a combination thereof, but are not limited thereto.

The other additives may be included in an amount of about 0.2 wt % to about 20 wt % based on a total weight of the electrolyte for a rechargeable lithium battery. For example, the other additives may be included in an amount of about 0.5 wt % to about 15 wt %, for example, about 1 wt % to about 10 wt %, based on 100 wt % of the electrolyte. If the other additives are included in the above ranges, capacity characteristics and cycle-life characteristics of the battery may be effectively improved under high-voltage driving conditions.

### Non-Aqueous Organic Solvent

The non-aqueous organic solvent serves as a medium for transmitting ions taking part in the electrochemical reaction of a battery.

For example, the non-aqueous organic solvent may include an ester-based solvent, and for example, the non-aqueous organic solvent may include an ester-based solvent having excellent high-voltage characteristics. According to some embodiments, the non-aqueous organic solvent may include ethyl butyrate (EB), an ester-based solvent having very excellent high-voltage characteristics. The ethyl butyrate has excellent high-voltage characteristics and is suitable for use in a high-voltage rechargeable lithium battery of 4.5V or higher. However, because there is a problem of discoloration of the other electrolyte as described above, it is possible to implement a rechargeable lithium battery having excellent high-voltage characteristics while solving the problem of discoloration by using in combination with the borate compound.

The ethyl butyrate may be included in an amount of about 50 vol % to about 90 vol % based on 100 vol % of the non-aqueous organic solvent. For example, the ethyl butyrate may be included in an amount of about 60 vol % to about 90 vol %, for example, about 60 vol % to about 80 vol %, based on 100 vol % of the non-aqueous organic solvent. If the ethyl butyrate is included in the above range, a rechargeable lithium battery having excellent high-voltage characteristics may be effectively implemented. The non-aqueous organic solvent may further include other ester-based solvents in addition to ethyl butyrate. The ester-based solvent may include, for example, methyl acetate, ethyl acetate, n-propyl acetate, dimethyl acetate, methyl propionate, ethyl propionate, propyl propionate, γ-butyrolactone, decanolide, valerolactone, mevalonolactone, caprolactone, and/or the like.

In some embodiments, the non-aqueous organic solvent may further include a carbonate-based solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

In some embodiments of the carbonate-based solvent, a mixture of cyclic carbonate and chain carbonate may be used. In some embodiments, if the cyclic carbonate and the chain carbonate are mixed together in a volume ratio of about 1:1 to about 1:9, the performance of the electrolyte may be improved.

The non-aqueous organic solvent may further include an ether-based solvent, a ketone-based solvent, an alcohol-based solvent, and/or an aprotic solvent.

The ether-based solvent may include, for example, dibutyl ether, tetraglyme, diglyme, dimethoxyethane, 2-methyltetrahydrofuran, tetrahydrofuran, and/or the like. The ketone-based solvent may include cyclohexanone and/or the like, and the alcohol-based solvent may include ethyl alcohol and/or isopropyl alcohol. The aprotic solvent may include nitriles such as R—CN (where R is a C2 to C20 linear, branched, or cyclic hydrocarbon group and may include a double bond, an aromatic ring, and/or an ether bond), amides such as dimethylformamide, dioxolanes such as 1,3-dioxolane, and/or sulfolanes.

The above non-aqueous organic solvents may be used alone or in combination with one or more of them, and if used in combination with one or more, a mixing ratio may be suitably or appropriately adjusted according to suitable or desired battery performance, which should be understood by those skilled in the art upon review of this disclosure.

The non-aqueous organic solvent may further include an aromatic hydrocarbon-based organic solvent.

The aromatic hydrocarbon-based solvent may be an aromatic hydrocarbon-based compound of Chemical Formula I.

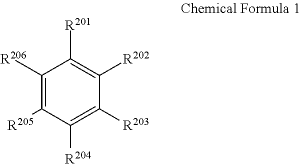

In Chemical Formula I, R²⁰¹ to R²⁰⁶ are the same or different and are selected from hydrogen, a halogen, a C1 to C10 alkyl group, a C1 to C10 haloalkyl group, and a combination thereof.

Examples of the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate and/or an ethylene carbonate-based compound represented by Chemical Formula II in order to improve cycle-life of a battery.

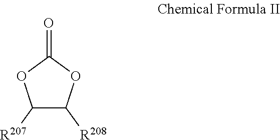

In Chemical Formula II, R²⁰⁷ and R²⁰⁸ are the same or different, and are hydrogen, a halogen, a cyano group, a nitro group, or a fluorinated C1 to C5 alkyl group, provided that at least one selected from R²⁰⁷ and R²⁰⁸ is a halogen, a cyano group, a nitro group, or a fluorinated C1 to C5 alkyl group, and R²⁰⁷ and R²⁰⁸ are not simultaneously hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within a suitable or appropriate range.

### Lithium Salt

The lithium salt dissolved in the non-organic solvent supplies lithium ions in a battery, enables a basic operation of a rechargeable lithium battery, and improves transportation of the lithium ions between positive and negative electrodes.

Examples of the lithium salt include at least one selected from LiPF₆, LiBF₄, LiSbF₆, LiAsF₆, LiN(SO₂C₂F₅)₂, Li(CF₃SO₂)₂N, LIN (SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein, x and y are natural numbers, for example, an integer in a range from 1 to 20, lithium difluoro (bisoxalato) phosphate, LiCl, Lil, LiB(C₂O₄)₂ (lithium bis(oxalato) borate, LiBOB), and lithium difluoro (oxalato) borate (LiDFOB).

The lithium salt may be used in a concentration in a range from about 0.1 M to about 2.0 M. If the lithium salt is included at the above concentration range, an electrolyte may have excellent performance and lithium ion mobility due to suitable or optimal electrolyte conductivity and viscosity.

### Positive Electrode

The positive electrode may include a current collector and a positive electrode active material layer on the current collector. The positive electrode active material layer may include a positive electrode active material, and may optionally further include a binder and/or a conductive material (e.g., an electrically conductive material).

The positive electrode active material may be applied without limitation as long as it is generally used in a rechargeable lithium battery. For example, the positive electrode active material may be a compound capable of reversible intercalation and deintercalation of lithium, and may include a compound represented by one selected from the following chemical formulas.
LiₐA_{1-b}X_{b}D₂ (0.90≤a≤1.8, 0≤b≤0.5);
LiₐA_{1-b}X_{b}O_{2-c}D_{c} (0.90≤a≤1.8, 0≤b≤0.5, 0≤c≤0.05);
LiₐE_{1-b}X_{b}O_{2-c}D_{c} (0.90≤a≤1.8, 0≤b≤0.5, 0≤c≤0.05);
LiₐE_{2-b}X_{b}O_{4-c}D_{c} (0.90≤a≤1.8, 0≤b≤0.5, 0≤c≤0.05);
LiₐNi_{1-b-c}Co_{b}X_{c}D_{α} (0.90≤a≤1.8, 0≤b≤0.5, 0≤c≤0.5, 0<α≤2);
LiₐNi_{1-b-c}Co_{b}X_{c}O_{2-α}T_{α} (0.90≤a≤1.8, 0≤b≤0.5, 0≤c≤0.05, 0<α<2);
LiₐNi_{1-b-c}Co_{b}X_{c}O_{2-α}T₂ (0.90≤a≤1.8, 0≤b≤0.5, 0≤c≤0.05, 0<α<2);
LiₐNi_{1-b-c}Mn_{b}X_{c}D_{α} (0.90≤a≤1.8, 0≤b≤0.5, 0≤c≤0.05, 0<α≤2);
LiₐNi_{1-b-c}Mn_{b}X_{c}O_{2-α}T_{α} (0.90≤a≤1.8, 0≤b≤0.5, 0≤c≤0.05, 0<α<2);
LiₐNi_{1-b-c}Mn_{b}X_{c}O_{2-α}T₂ (0.90≤a≤1.8, 0≤b≤0.5, 0≤c≤0.05, 0<α<2);
LiₐNi_{b}E_{c}G_{d}O₂ (0.90≤a≤1.8, 0≤b≤0.9, 0≤c≤0.5, 0.001≤d≤0.1);
LiₐNi_{b}Co_{c}Mn_{d}GₑO₂ (0.90≤a≤1.8, 0≤b≤0.9, 0≤c≤0.5, 0≤d≤0.5, 0.001≤e≤0.1);
LiₐNiG_{b}O₂ (0.90≤a≤1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li_{(3-f)}J₂(PO₄)₃ (0≤f≤2);
Li_{(3-f)}Fe₂(PO₄)₃(0≤f≤2); and
LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), and/or lithium iron phosphate oxide (LFP).

In some embodiments, the positive electrode active material may include a lithium cobalt-based oxide. A positive electrode using lithium cobalt-based oxide as a positive electrode active material can suppress or reduce battery resistance and improve overall battery performance by exhibiting a synergistic effect in a 4.5 V-class high-voltage design and/or rapid charging system if used with the above-described electrolyte.

The lithium cobalt-based oxide may be for example represented by Chemical Formula 3.

Liₐ₁Coₓ₁M¹₍₁₋ₓ₁₎O₂ Chemical Formula 3

In Chemical Formula 3, 0.9≤a1≤1.8, and 0.7≤x1≤1, and M¹ is one or more elements selected from Al, B, Ba, Ca, Ce, Cr, Cu, F, Fe, Mg, Mn, Mo, Ni, P, S, Se, Si, Sr, Ti, V, W, Y, Zn, and Zr.

In Chemical Formula 3, x₁ represents a molar content of cobalt and may be, for example, 0.8≤x1≤1, 0.9≤x1≤1, or 0.95≤x1≤1.

An average particle diameter (D50) of the positive electrode active material may be about 1 μm to about 25 μm, for example, about 3 μm to about 25 μm, about 5 μm to about 25 μm, about 5 μm to about 20 μm, about 8 μm to about 20 μm, or about 10 μm to about 18 μm. A positive electrode active material having such a particle size range can be harmoniously or homogeneously mixed together with other components in a positive electrode active material layer and can realize high capacity and high energy density. In some embodiments, the average particle diameter (D50) may be measured by a particle size analyzer using a laser diffraction method, and may mean a diameter of particles whose cumulative volume is 50 vol % in the particle size distribution.

The positive electrode active material may be in the form of secondary particles formed by aggregating a plurality of primary particles, or may be in the form of single particles. In some embodiments, the positive electrode active material may have a spherical or near-spherical shape, or may have a polyhedral or amorphous shape.

The positive electrode active material layer may include a binder. The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

A content of the binder in the positive electrode active material layer may be approximately about 0.5 wt % to about 5 wt % based on a total weight of the positive electrode active material layer.

The positive electrode active material layer may include a conductive material (e.g., an electrically conductive material). The conductive material is used to impart conductivity (e.g., electrical conductivity) to the electrode, and any suitable material that does not cause a chemical change (e.g., does not cause a substantial undesirable chemical change) and conducts electrons can be used in the battery. Examples of the conductive material may include a carbon-based material such as natural graphite, artificial graphite, carbon black, acetylene black, ketjen black, carbon fiber, carbon nanofiber, and carbon nanotube; a metal-based material containing copper, nickel, aluminum, silver, etc., in the form of a metal powder or a metal fiber; a conductive polymer such as a polyphenylene derivative; or a mixture thereof.

A content of the conductive material in the positive electrode active material layer may be about 1 wt % to about 5 wt % based on the total weight of the positive electrode active material layer.

An aluminum foil may be used as the positive electrode current collector, but is not limited thereto.

### Negative Electrode

A negative electrode for a rechargeable lithium battery includes a current collector and a negative electrode active material layer on the current collector. The negative electrode active material layer may include a negative electrode active material, and may further include a binder and/or a conductive material (e.g., an electrically conductive material).

The negative electrode active material includes a material capable of reversibly intercalating/deintercalating lithium ions, lithium metal, a lithium metal alloy, a material capable of doping and undoping lithium, and/or a transition metal oxide.

The material capable of reversibly intercalating/deintercalating the lithium ions may be a carbon-based negative electrode active material, and may include, for example, crystalline carbon, amorphous carbon, or a combination thereof. The crystalline carbon may be irregular, or plate, flake, spherical, or fiber shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may be silicon, a silicon-carbon composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, and not Si), and/or the like, and the Sn-based negative electrode active material may be Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, and not Sn) and/or the like. At least one of these materials may be mixed together with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer on the surface of the core. The crystalline carbon may be artificial graphite, natural graphite, or a combination thereof. The amorphous carbon precursor may include a coal-based pitch, mesophase pitch, a petroleum-based pitch, coal-based oil, petroleum-based heavy oil, and/or a polymer resin such as a phenolic resin, a furan resin, and/or a polyimide resin. In some embodiments, a content of silicon may be about 10 wt % to about 50 wt % based on the total weight of the silicon-carbon composite. In some embodiments, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In some embodiments, a thickness of the amorphous carbon coating layer may be about 5 nm to about 100 nm. An average particle diameter (D50) of the silicon particles may be about 10 nm to about 20 μm. The average particle diameter (D50) of the silicon particles may be desirably about 10 nm to about 200 nm. The silicon particles may be present in an oxidized form, and an atomic content ratio of Si:O in the silicon particles indicating a degree of oxidation may be about 99:1 to about 33:67. The silicon particles may be SiOₓ particles, and the range of x in SiOₓ may be greater than about 0 and less than about 2. In the present specification, if a definition is not otherwise provided, an average particle diameter (D50) indicates a particle where an accumulated volume is about 50 vol % in a particle distribution.

The Si-based negative electrode active material or Sn-based negative electrode active material may be mixed together with the carbon-based negative electrode active material. If the Si-based negative electrode active material and/or Sn-based negative electrode active material and carbon-based negative electrode active material are mixed together, a mixing ratio thereof may be about 1:99 to about 90:10 by weight ratio.

In the negative electrode active material layer, the negative electrode active material may be included in an amount of about 95 wt % to about 99 wt % based on a total weight of the negative electrode active material layer.

In some embodiments, the negative electrode active material layer may further include a binder, and may optionally further include a conductive material (e.g., an electrically conductive material). A content of the binder in the negative electrode active material layer may be about 1 wt % to about 5 wt % based on the total weight of the negative electrode active material layer. In some embodiments, if the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to well attach the negative electrode active material particles to each other and also to well attach the negative electrode active material to the current collector. The binder may include a non-aqueous binder, an aqueous binder, a dry binder, or a combination thereof.

The non-water-soluble binder may be selected from polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may be a rubber-based binder and/or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluorine rubber, and a combination thereof. The polymer resin binder may be selected from polyethylene oxide, polyvinylpyrrolidone, polyepichlorohydrine, polyphosphazene, polyacrylonitrile, an ethylene propylene diene copolymer, polyvinylpyridine, chlorosulfonated polyethylene, a latex, a polyester resin, an acrylic resin, a phenolic resin, an epoxy resin, polyvinyl alcohol, and a combination thereof.

If the water-soluble binder is used as a negative electrode binder, a cellulose-based compound may be further used to provide viscosity as a thickener. The cellulose-based compound may include one or more of carboxymethyl cellulose, hydroxypropylmethyl cellulose, methyl cellulose, and/or alkali metal salts thereof. The alkali metals may be Na, K, and/or Li. Such a thickener may be included in an amount of about 0.1 to about 3 parts by weight based on 100 parts by weight of the negative electrode active material.

The conductive material is included to provide electrode conductivity (e.g., electrical conductivity) and any suitable electrically conductive material may be used as a conductive material unless it causes a chemical change (e.g., a substantial undesirable chemical change). Examples of the conductive material include a carbon-based material such as natural graphite, artificial graphite, carbon black, acetylene black, ketjen black, a carbon fiber, a carbon nanotube, and the like; a metal-based material having a shape of a metal powder or a metal fiber including copper, nickel, aluminum silver, or the like; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal (e.g., an electrically conductive metal), and a combination thereof.

The negative electrode according to some embodiments may have density of greater than or equal to about 1.6 g/cc. The density of the negative electrode may be expressed as density of a negative electrode mixture, which may mean density of the negative electrode after compressing. For example, the density of the negative electrode may be measured by drying and compressing a negative electrode active material composition after coating it on the negative electrode current collector and calculated by dividing a weight of components (negative electrode active material, binder, conductive material, etc.) excluding the current collector from the negative electrode by a volume of the components.

If the negative electrode has high density of greater than about 1.6 g/cc, a high-capacity battery may be realized, but because lithium dendrites are produced at the negative electrode if driven at a high voltage, both capacity characteristics and cycle-life characteristics may be improved by using the borate compound and the Ag salt together according to some embodiments.

### Separator

The separator 113 separates a positive electrode 114 and a negative electrode 112 and provides a transporting passage for lithium ions and may be any suitable separator generally-used in a lithium ion battery. The separator may have low resistance to ion movement of the electrolyte and excellent ability to absorb the electrolyte. The separator may include, for example, a glass fiber, polyester, polyethylene, polypropylene, polytetrafluoroethylene, or a combination thereof and may have a form of a non-woven fabric or a woven fabric. For example, in a lithium ion battery, a polyolefin-based polymer separator such as polyethylene and/or polypropylene is mainly used. In order to ensure the heat resistance and/or mechanical strength, a coated separator including a ceramic component and/or a polymer material may be used. Optionally, it may have a mono-layered or multi-layered structure.

Rechargeable lithium batteries may be classified as lithium ion batteries, lithium ion polymer batteries, or lithium polymer batteries according to the presence of a separator and the type or kind of electrolyte used therein. The rechargeable lithium batteries may have a variety of shapes and sizes, and include cylindrical, prismatic, coin, or pouch-type batteries, and may be thin film batteries or may be rather bulky in size. Structures and manufacturing methods for lithium ion batteries pertaining to this disclosure may be any suitable ones generally used in the art.

The rechargeable lithium battery according to some embodiments may be used in an electric vehicle (EV), a hybrid electric vehicle such as a plug-in hybrid electric vehicle (PHEV), and portable electronic device because it implements a high capacity and has excellent storage stability, cycle-life characteristics, and high rate characteristics at high temperatures.

Examples and comparative examples of the present disclosure are described below. However, the following examples are only examples of the present disclosure, and the present disclosure is not limited to the following examples.

### EXAMPLE

### 1. Preparation of Electrolyte

Hereinafter, “wt %” in the composition of the electrolyte is based on the total content of the electrolyte (lithium salt+non-aqueous organic solvent+additive+other additives, etc.).

A base electrolyte is prepared by mixing together ethylene carbonate (EC), propylene carbonate (PC), and ethyl butyrate (EB) sequentially in a volume ratio of 10:15:75 to prepare a non-aqueous organic solvent, dissolving 1.3 M LiPF₆ lithium salt in the non-aqueous organic solvent, and adding 7 wt % of FEC, 1 wt % of VEC, 0.2 wt % of LiBF₄, 3 wt % of PS, 2 wt % of SN, and 3 wt % HTCN as other additives thereto.

To the base electrolyte, 1 wt % of a borate compound (LiFDB) represented by Chemical Formula 1-1 and 0.5 wt % of AgNO₃ are added, thereby preparing an electrolyte according to an example.

### 2. Manufacturing of Rechargeable Lithium Battery Cell

LiCoO₂ as a positive electrode active material, polyvinylidene fluoride as a binder, and ketjen black as a conductive material are mixed together in a weight ratio of 97:2:1 and then, dispersed in N-methyl pyrrolidone, thereby preparing a positive electrode active material slurry. The positive electrode active material slurry is coated on a 14 μm-thick Al foil current collector, dried at 110° C., and compressed, thereby manufacturing a positive electrode.

A negative electrode active material slurry is prepared by mixing together artificial graphite as a negative electrode active material, a styrene-butadiene rubber as a binder, and carboxylmethyl cellulose as a thickener in a weight ratio of 97:1:2 and then, dispersing the mixture in distilled water. The negative electrode active material slurry is coated on a 10 μm-thick Cu foil current collector, dried at 100° C., and compressed, manufacturing a negative electrode. Herein, the negative electrode is measured with respect to a weight of each component excluding the current collector, which is divided by a volume, thereby obtaining 1.6 g/cc of density of the negative electrode.

Between the positive electrode and the negative electrode, a 25 μm-thick separator having a polyethylene-polypropylene multi-layer structure is provided, thereby manufacturing an electrode assembly, and after housing the electrode assembly into a pouch-type battery case, an electrolyte is injected thereinto, thereby manufacturing a 4.5 V-class rechargeable lithium battery cell.

### Comparative Examples 1 to 7

An electrolyte and a rechargeable lithium battery are prepared in substantially the same manner as in Example except that each electrolyte is prepared by changing types and amounts of the non-aqueous organic solvent, the weight of a borate compound (LiFDB) represented by Chemical Formula 1-1, the weight of AgNO₃, and the density of the negative electrode as shown in Table 1. For reference, PP is propyl propionate in Table 1.

TABLE 1

| | Negative | Composition of the electrolyte | | | | | |
|---|---|---|---|---|---|---|---|
| | electrode | Non-aqueous organic | | | | | |
| | density | solvent (vol %) | | | | LiFDB | AgNO₃ |
| | (g/cc) | EC | PC | PP | EB | (wt %) | (wt %) |
| Example | 1.6 | 10 | 15 | 0 | 75 | 1 | 0.5 |
| Comparative Example 1 | 1.6 | 10 | 15 | 75 | 0 | 0 | 0 |
| Comparative Example 2 | 1.6 | 10 | 15 | 0 | 75 | 0 | 0 |
| Comparative Example 3 | 1.6 | 10 | 15 | 75 | 0 | 1 | 0 |
| Comparative Example 4 | 1.6 | 10 | 15 | 0 | 75 | 1 | 0 |
| Comparative Example 5 | 1.5 | 10 | 15 | 0 | 75 | 0 | 0 |
| Comparative Example 6 | 1.5 | 10 | 15 | 0 | 75 | 1 | 0.5 |
| Comparative Example 7 | 1.6 | 10 | 15 | 0 | 75 | 0 | 0 |

### Evaluation Example 1: Discoloration of Electrolyte

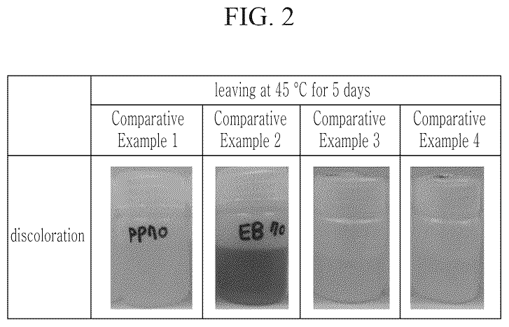

The electrolytes for a rechargeable lithium battery according to the Example and Comparative Examples 1 to 7 are left for 5 days at 45° C. and then, examined with respect to discoloration, and if discolored, 0 is given, but if not discolored, X is given, and the results are shown in Table 2. Whether or not the electrolytes of Comparative Examples 1 to 4 are discolored is shown as photographs in FIG. 2.

### Evaluation Example 2: Evaluation of Cycle-life Characteristics at 45° C. High Temperature

The rechargeable lithium battery cells of the Example and Comparative Examples 1 to 7 are charged from 3.0 V to an upper limit of 4.5 V under a constant current condition of 1.5 C, paused for 10 minutes, and discharged to 3.0 V under a condition of 1.0 C at 45° C. for initial charge and discharge. Subsequently, the rechargeable lithium battery cells are 150 times repeatedly charged and discharged at 1.0 C/1.0 C within a range of 3.0 V to 4.5 V at 45° C.

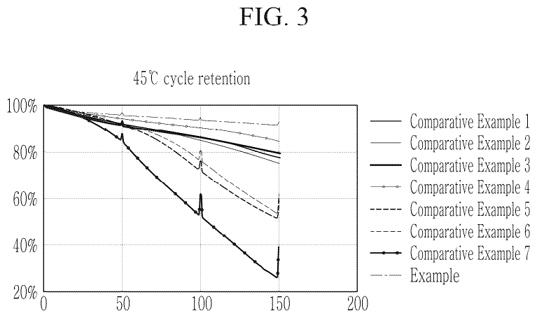

A ratio of discharge capacity at the 150 cycles to the initial discharge capacity is calculated and then, provided as high temperature capacity retention in Table 2, and high temperature (45° C.) capacity retention during the 150 cycles is shown in FIG. 3.

### Evaluation Example 3: Generation of Lithium Dendrites

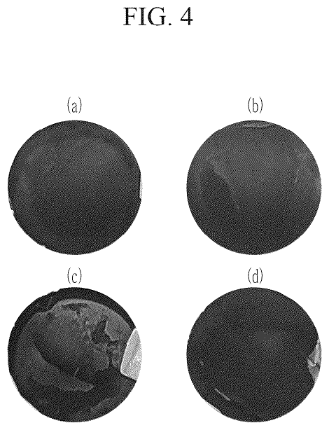

The rechargeable lithium battery cells of the Example and Comparative Examples 1 to 7 are charged from 3.0 V to an upper limit of 4.5 V under a constant current condition of 1.5 C at 45° C., and whether or not lithium dendrites are produced on the surface of the negative electrodes is examined, and the results are shown in Table 2. Herein, if the lithium dendrites are produced on the surface of the negative electrodes, 0 is given, but if not produced, X is given. FIG. 4 is a series of photographs showing whether or not the lithium dendrites are produced in the rechargeable lithium batteries, wherein (a) is Comparative Example 5, (b) is Comparative Example 6, (c) is Comparative Example 7, and (d) is the Example. Referring to FIG. 4, in Comparative Example 7 (c), the lithium dendrites are produced.

TABLE 2

| | | High-temperature | |
|---|---|---|---|
| | Discolora- | capacity retention | Generation |
| | tion of | rate (%) (@150 | of lithium |
| | electrolyte | cycles) | dendrites |
| Example | X | 91.6 | X |
| Comparative Example 1 | X | 77.7 | X |
| Comparative Example 2 | ◯ | 75.4 | 0 |
| Comparative Example 3 | X | 79.5 | X |
| Comparative Example 4 | X | 84.5 | X |
| Comparative Example 5 | ◯ | 51.7 | X |
| Comparative Example 6 | X | 53.6 | X |
| Comparative Example 7 | ◯ | 25.9 | ◯ |

Referring to Table 2 and FIGS. 2-4, the electrolyte of the Example is not discolored, compared with those of the comparative examples, but exhibits excellent cycle-life characteristics at a high temperature and no formation (or no observable formation) of the lithium dendrites at the negative electrode. Referring to Table 2, if EB is not used as the non-aqueous organic solvent (Comparative Examples 1 and 3), the electrolytes are not discolored, but high temperature capacity retention thereof is lower than that of the Example.

If EB is used as the non-aqueous organic solvent but not used with LiFDB (Comparative Examples 2, 5, and 7), the electrolytes thereof are discolored, and high temperature capacity retention thereof is lower than that of the Example.

If EB is used as the non-aqueous organic solvent and used with LiFDB but not with AgNO₃ (Comparative Example 4), high temperature capacity retention thereof is lower than that of the Example.

If EB is used as the non-aqueous organic solvent and used with LiFDB and AgNO₃, but the negative electrode density is less than 1.6 g/cc (Comparative Example 6), the electrolyte thereof is not discolored, and the lithium dendrites are not produced (or not observably produced) at the negative electrode, but high temperature capacity retention thereof is significantly deteriorated, compared with that of the Example.

While the subject matter of this disclosure has been described in connection with what is presently considered to be practical example embodiments, it is to be understood that the present disclosure is not limited to the disclosed embodiments. On the contrary, it is intended to cover various modifications and equivalent arrangements included within the spirit and scope of the appended claims, and equivalents thereof.

### DESCRIPTION OF SYMBOLS

| | |
|---|---|
| 100: rechargeable lithium battery | 112: negative electrode |
| 113: separator | 114: positive electrode |
| 120: battery case | 140: sealing member |

What is claimed is:

1. A rechargeable lithium battery, comprising:
a positive electrode comprising a positive electrode active material,
a negative electrode comprising a negative electrode active material,
a separator between the positive electrode and the negative electrode, and
an electrolyte,
wherein a density of the negative electrode is greater than or equal to about 1.6 g/cc,
the electrolyte comprises a non-aqueous organic solvent, a lithium salt, and an additive,
the non-aqueous organic solvent comprises ethyl butyrate, and
the additive comprises a borate compound represented by Chemical Formula 1 and an Ag salt:
LiBF₂[O₂C(CFX)ₙCO₂] Chemical Formula 1
wherein, in Chemical Formula 1, X is hydrogen, a halogen, a substituted or unsubstituted C1 to C4 alkyl group, or a C1 to C4 fluoroalkyl group substituted with at least one fluoro group, and n is an integer of 1 to 4.

2. The rechargeable lithium battery as claimed in claim 1, wherein:
the ethyl butyrate is included in an amount of about 50 vol % to about 90 vol % based on 100 vol % of the non-aqueous organic solvent.

3. The rechargeable lithium battery as claimed in claim 1, wherein:
the non-aqueous organic solvent further comprises a carbonate-based solvent.

4. The rechargeable lithium battery as claimed in claim 1, wherein
the compound represented by Chemical Formula 1 is represented by any one selected from Chemical Formula 1-1 to Chemical Formula 1-6:

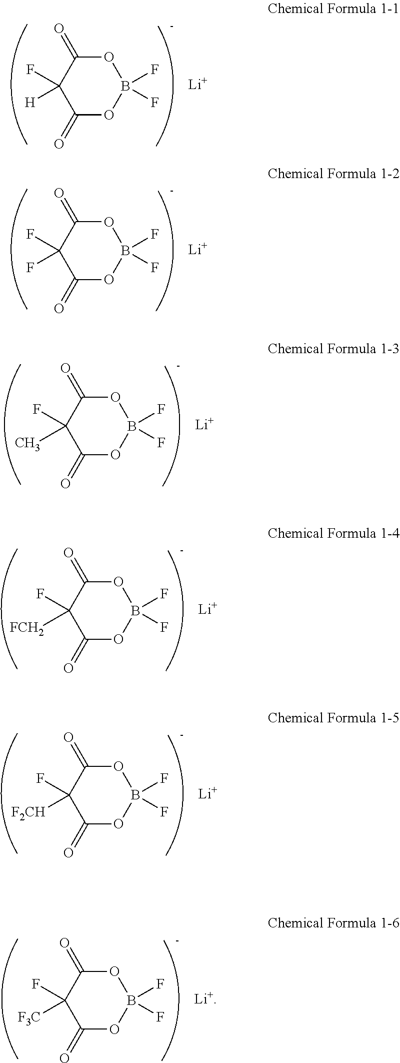

5. The rechargeable lithium battery as claimed in claim 1, wherein:
the borate compound represented by Chemical Formula 1 is included in an amount of about 1 wt % to about 10 wt % based on a total weight of the electrolyte.

6. The rechargeable lithium battery as claimed in claim 1, wherein:
the Ag salt comprises at least one selected from AgNO₃, AgNO₂, AgN₃, AgCN, AgPF₆, AgFSI, AgTFSI, AgF, AgSO₃CF₃, and AgBF₄.

7. The rechargeable lithium battery as claimed in claim 1, wherein:
the Ag salt is included in an amount of about 0.1 wt % to about 10 wt % based on a total weight of the electrolyte for a rechargeable lithium battery.

8. The rechargeable lithium battery as claimed in claim 1, wherein:
the borate compound represented by Chemical Formula 1 and the Ag salt are included in a weight ratio of about 1:0.1 to about 1:1.

9. The rechargeable lithium battery as claimed in claim 1, wherein:
the electrolyte further comprises other additives, and
the other additives comprise at least one selected from vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), and a combination thereof.

10. The rechargeable lithium battery as claimed in claim 1, wherein:
the positive electrode active material comprises a lithium cobalt-based oxide.

11. The rechargeable lithium battery as claimed in claim 10, wherein:
the lithium cobalt-based oxide is represented by Chemical Formula 3:
Liₐ₁Coₓ₁M¹₍₁₋ₓ₁₎O₂ Chemical Formula 3
wherein, in Chemical Formula 3, 0.9≤a1≤1.8, 0.7≤x1≤1, and M¹ is one or more element selected from Al, B, Ba, Ca, Ce, Cr, Cu, F, Fe, Mg, Mn, Mo, Ni, P, S, Se, Si, Sr, Ti, V, W, Y, Zn, and Zr.

12. The rechargeable lithium battery as claimed in claim 1, wherein:
the negative electrode active material comprises crystalline carbon.
